(19) United States
(12) Patent Application Publication
(10) Pub. No.: US 2019/0117502 A1
(43) Pub. Date: Apr. 25, 2019

(54) Patient Support Apparatus for Releasably Securing a Chest Compression System

(71) Applicant: Stryker Corporation, Kalamazoo, MI (US)

(72) Inventors: Michael Arbuck, Amsterdam (NL); Erik von Schenck, Redmond, WA (US)

(73) Assignee: Stryker Corporation, Kalamazoo, MI (US)

(21) Appl. No.: 16/163,978

(22) Filed: Oct. 18, 2018

Related U.S. Application Data
(60) Provisional application No. 62/574,556, filed on Oct. 19, 2017.

(51) Int. Cl. A61H 31/00

(52) U.S. Cl. CPC A61H 31/006; A61H 31/005; A61H 31/008; A61H 2011/005; A61G 2200/327; A61H 2201/5084; A61H 2201/018; A61H 2201/5064

(57) ABSTRACT

A patient support apparatus for releasably securing a chest compression system for providing automatic chest compressions. A patient support surface of the patient support apparatus is sized to support a back plate of the chest compression system and at least a majority of the patient. A harness assembly includes at least one retention strap coupled to each of opposing lengthwise sides of the frame, and a coupler near an end of each of the retention straps. The couplers releasably engage complementary couplers of the chest compression system when the back plate is positioned on the patient support surface. A tension adjustment mechanism is coupled to the retention straps to selectively adjust tension of one or more of the retention straps to secure the chest compression system to the patient support apparatus when the couplers are coupled to the complementary couplers of the chest compression system.

### CROSS REFERENCE TO RELATED APPLICATIONS

This application claims priority to and the benefit of U.S. Provisional Patent Application No. 62/574,556, filed on Oct. 19, 2017, and entitled PATIENT GURNEY OR COT WITH SECURING RESTRAINT, the entire contents of which are hereby incorporated by reference.

### BACKGROUND

Patient support apparatuses, such as hospital beds, stretchers, cots, and tables, facilitate care of patients. Cardiopulmonary resuscitation (CPR) is a lifesaving technique useful in many medical emergencies, for example following a heart attack or near drowning, in which a person's breathing and/or heartbeat has stopped. Chest compressions are a primary aspect of CPR and involve firmly compressing the chest of the person to facilitate oxygenated blood to remain flowing to the brain and other vital organs until more definitive medical treatment can restore a normal heart rhythm. Rescue breathing may also be provided between the cycles of the chest compressions. The administration of CPR requires the effort and attention of an individual, for example, an emergency medical technician (EMT), who is consequently unable to perform other treatment modalities that may benefit the person suffering the medical emergency.

Devices have been developed that provide automatic chest compressions. One such device is the LUCAS™ family of chest compression systems, available from Physio-Control, Inc. The chest compression system utilizes a mechanical plunger to provide the chest compressions with the appropriate force at the appropriate intervals. One especially useful application of the chest compression system is during transport of a patient supported on a patient support apparatus, such as hospital bed, stretcher, cot, and the like. For example, providing automatic chest compressions during ambulance transport—often associated with high-speed driving, risky maneuvers, and/or hazardous road conditions—may mitigate the need for EMTs to perform CPR while standing unrestrained in a confined space. Another example is providing the automatic chest compressions while the patient is supported on the patient support apparatus in the hospital setting. Yet, due to the elevation of the patient support surface on which the patient is supported, especially during ambulance transport, the EMTs or other treating medical professionals may need to closely monitor the stability of the chest compression system (and the patient) supported on the patient support apparatus, and further manually assist with stabilizing the same. As a result, those medical professionals may be prevented from performing other treatment modalities that may benefit the person suffering the medical emergency.

A patient support apparatus designed to address one or more of the aforementioned challenges is desired.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a patient support apparatus in accordance with an exemplary embodiment of the present disclosure with the patient support apparatus releasably securing a chest compression system to a patient support surface with a harness assembly.

FIG. 2 is a top plan view of the patient support apparatus of FIG. 1 with the patient removed.

FIG. 3A is a perspective view of the chest compression system of FIG. 1.

FIG. 3B is a perspective view of the chest compression system of FIG. 1 with a harness assembly in accordance with an alternative embodiment of the present disclosure.

FIG. 3C is a perspective view of the chest compression system of FIG. 1 with a harness assembly in accordance with another alternative embodiment of the present disclosure.

FIG. 4 is an elevational view showing the chest compression system of FIG. 1 supported on the patient support surface and readied to provide chest compressions to the patient.

FIG. 5 is a schematic illustration of an actuator of the harness assembly.

FIG. 6 is a perspective view of a patient support apparatus in accordance with another exemplary embodiment of the present disclosure with the patient support apparatus releasably securing the chest compression system.

FIG. 7 is an elevational view of the patient support apparatus of FIG. 6 with a schematic representation of the chest compression system.

### DETAILED DESCRIPTION

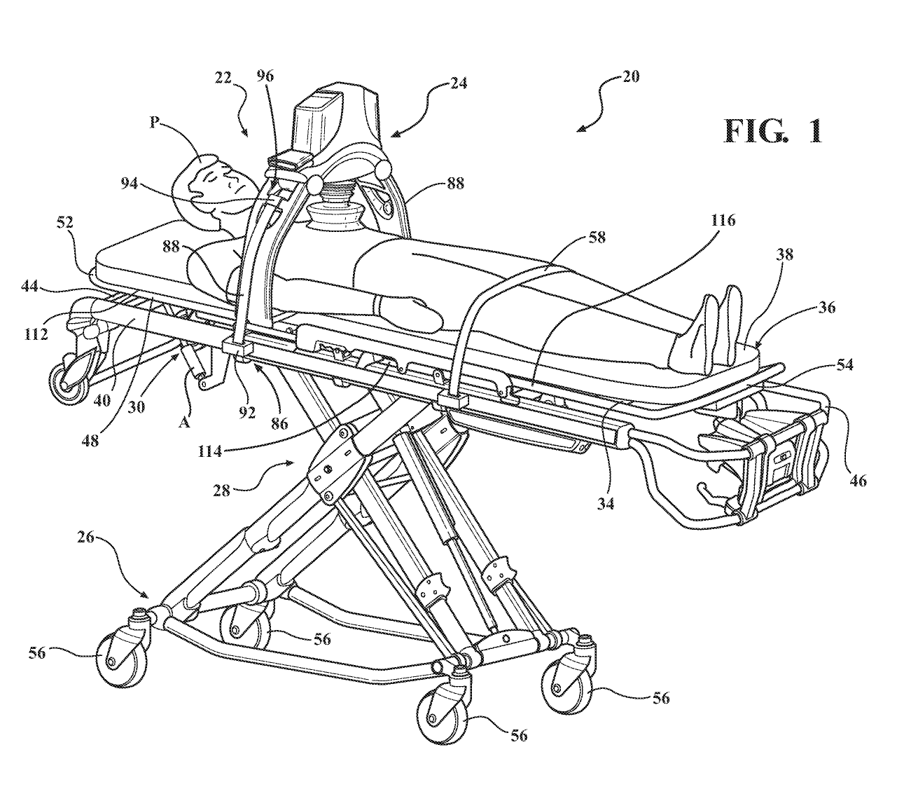

FIG. 1 illustrates a patient support system 20 in accordance with an exemplary embodiment. The patient support system 20 comprises a patient support apparatus 22 configured to support a chest compression system 24 and patient P above a floor/ground surface, particularly during transport along the surface. The patient support apparatus 22 of FIG. 1 is an ambulance cot supporting the patient P in a supine position above a floor surface. Exemplary ambulance cots may include models Power-PRO™ XT, Power-PRO™ IT, Performance-PRO™ XT, Power-PRO™ TL, MX-PRO® R3, MX-PRO® Bariatric Transport, and the M-1® Roll-in System, each from Stryker Corporation (Kalamazoo, Mich.), or other types of cots. In still other embodiments, the patient support apparatus 22 may comprise a hospital bed, stretcher, wheelchair, chair, or similar apparatus utilized in the transport of a patient generally positioned in the supine, incline, and/or decline positions.

The patient support apparatus 22 includes a base 26 and an intermediate support assembly 28. The intermediate support assembly 28 is disposed above and coupled to the base 26 as shown in FIG. 1. The intermediate support assembly 28 generally includes frame members and actuators configured to raise or lower the patient P supported on a patient support deck 34. In the exemplary embodiment of FIG. 1, raising or lowering of the patient support deck 34 relative to the base 26 results in a scissor-like motion of the intermediate support assembly 28. The construction of the base 26 and/or the intermediate support assembly 28 may take on any known or conventional design, and is not limited to that specifically set forth above.

Wheels 56 may be coupled to the base 26 to facilitate transport over surfaces. In the embodiment shown in FIG. 1, the wheels 56 are caster wheels arranged in each of four corners of the base 26, and adapted to rotate and swivel during transport. It should be understood that various configurations of the wheels 56 are contemplated, for example non-steerable, steerable, non-powered, powered, or combinations thereof. Additional wheels are also contemplated, or conversely, the patient support apparatus 22 may not comprise any wheels.

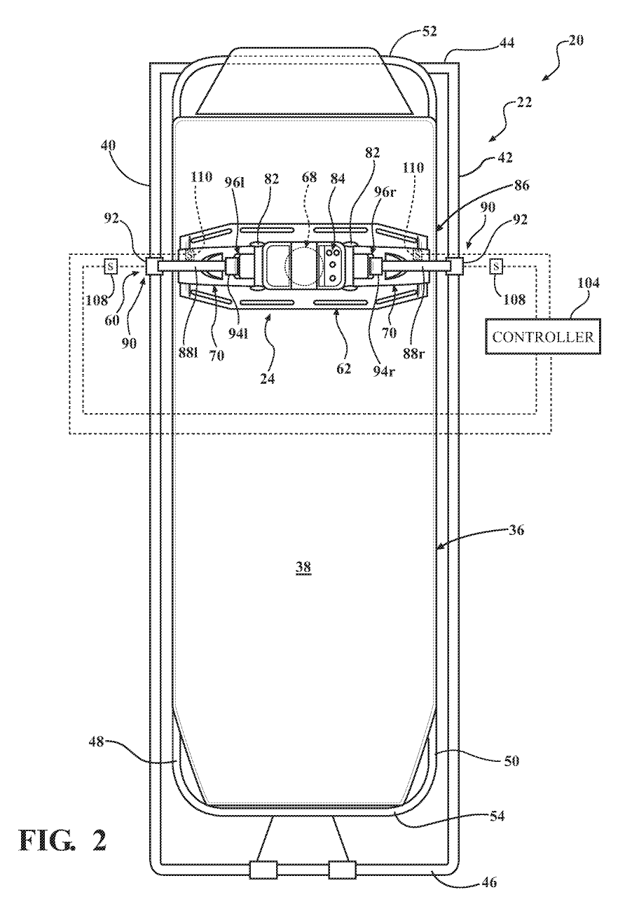

A support frame 30 is coupled to and positioned above the intermediate support assembly 28. The support frame 30 may further comprise frame rails 40, 42, 44, 46 supported by the intermediate support assembly 28 and/or the base 26. A first frame rail 40 is positioned at a left side of the support frame 30, and a second frame rail 42 is positioned at a right side of the support frame 30 when viewed in plan (see FIG. 2). The first and second frame rails 40, 42 may define opposing lengthwise sides of the support frame 30. A third frame rail 44 is positioned at the head end of the support frame 30, and a fourth frame rail 46 is positioned at the foot end of the support frame 30. The frame rails 40, 42, 44, 46, may directly or indirectly support the patient support deck 34 through suitable structural members, couplings, or connection means. The frame rails 40, 42, 44, 46 may be arranged in a substantially rectangular configuration to form a continuous loop. However, there may be greater or fewer than four frame rails, and any suitable construction of the support frame 30 may be employed, including constructions lacking any frame rails.

The support frame 30 includes the patient support deck 34. The patient support deck 34 may be defined between deck rails 48, 50, 52, 54 at least partially supported by the support frame 30. A first deck rail 48 is positioned at a left side of the patient support deck 34, and a second deck rail 50 is positioned at a right side of the patient support deck 34 when viewed in plan (see FIG. 2). The first and second deck rails 48, 50 may also be considered to define opposing lengthwise sides of the patient support deck 34. A third deck rail 52 is positioned at the head end of the patient support deck 34, and a fourth deck rail 54 is positioned at the foot end of the patient support deck 34. The deck rails 48, 50, 52, 54 may be arranged in a substantially rectangular configuration to form a continuous loop. A mattress 36 directly supports the patient P disposed thereupon. The mattress may be omitted in certain embodiments such that the patient rests directly on the patient support deck 34. The base 26, intermediate support assembly 28, patient support deck 34, and mattress 36 may each have a head end and a foot end corresponding to designated placement of the patient's head and feet, respectively, on the patient support apparatus 22.

The patient support apparatus 22 comprises a patient support surface 38 upon which the patient is supported. Any suitable structure of the patient support apparatus 22 may comprise at least a portion of the patient support surface 38 to support to the patient P, either directly or indirectly. For example, an upper surface of the mattress 36 and/or the patient support deck 34 may define the patient support surface 38. Additionally or alternatively, a separate, modular mattress pad adapted to be placed upon the mattress 36 may define the patient support surface 38. Support of the patient P could be effectuated in a number of different ways.

As mentioned, the patient support apparatus 22 is configured to support and transport the patient P over surfaces, which is inherently associated with risk of inadvertent patient egress. During transport, the patient should remain situated on the patient support surface 38 to avoid injury, and preferably immobilized to receive uncompromised treatment from attending caregivers. To that end, the patient support apparatus 22 comprises at least one patient strap 58 coupled to the support frame 30, for example one or more of the frame rails 40, 42, 44, 46 and/or the deck rails 48, 50, 52, 54 (patient support strap 58 removed in FIG. 2). FIG. 1 shows the patient strap 58 coupled to opposing frame rails 40, 42 and extending across the lower extremities of the patient P. In another example, additional patient straps secure the patient P proximate to the bilateral shoulders and/or the hips.

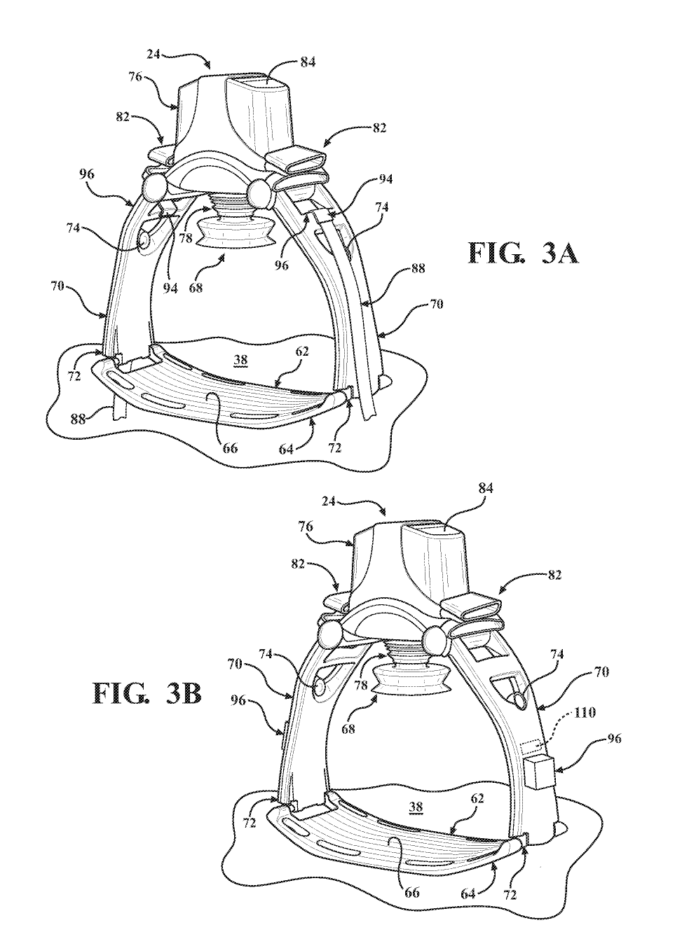

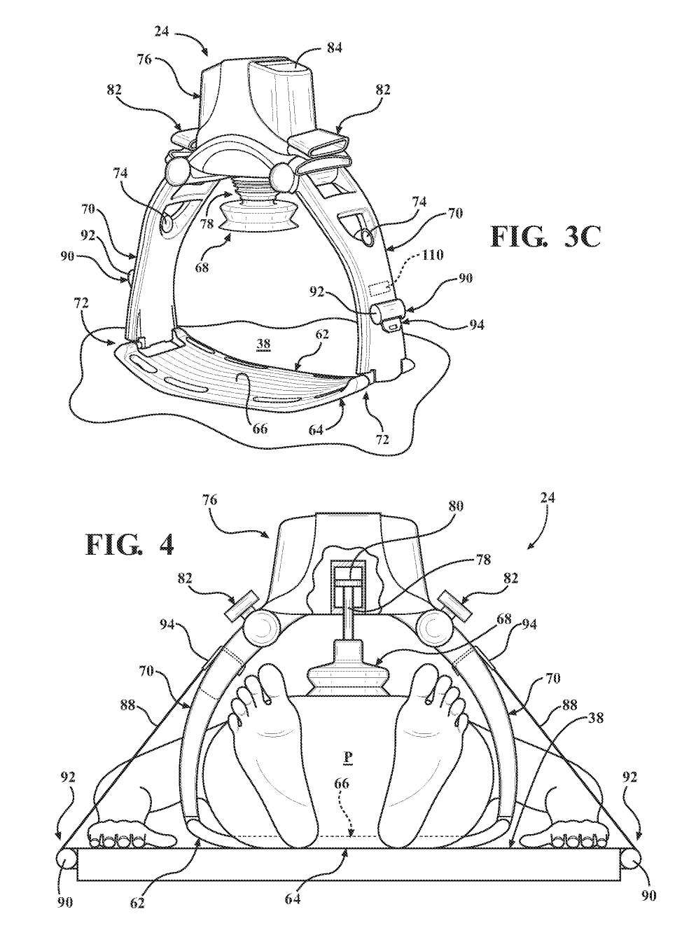

The chest compression system 24 will now be described with reference to FIGS. 3A-3C and 4. The chest compression system 24 includes a back plate 62. The back plate 62 includes a lower surface 64 disposed on the patient support surface 38, and an upper surface 66 opposite the lower surface 64 and sized to support a sufficient portion of the back of the patient P. The back plate 62 may be formed from suitably rigid materials such that, as the chest compressions are being provided from a chest pad 68, the downward force provided by the chest pad 68 is absorbed by the chest of the patient P and not undesirably dissipated to, for example, the mattress 36 upon which the patient P may be supported. Handles 82 may also be coupled to opposing upstanding legs 70 at a suitable position for securing the upper extremities of the patient P to, among other reasons, avoid interference with the operation of the chest compression system 24.

The chest compression system 24 includes the opposing upstanding legs 70 releasably coupled to the back plate 62. The opposing upstanding legs 70 may be pivotably coupled to the back plate 62. The opposing upstanding legs 70 are of a suitable length to at least partially define a volume of sufficient size to receive the torso of most patients based on anthropologic data. At a junction between each of the opposing upstanding legs 70 and the back plate 62 is a locking mechanism 72 releasably coupling an end of the opposing upstanding legs 70 and the back plate 62. Consequently, the back plate 62 may be separable from the remainder of the chest compression system 24 for storage and transport. More importantly, the separability of the back plate 62 facilitates quick positioning or engagement of the chest compression system 24 with the patient P. During operation, the back plate 62 may be situated on the patient support surface 38, after which the patient P is positioned on the back plate 62. The back plate 62 has a length sufficient such that opposing ends should extend beyond the profile of the patient P situated thereon. The remainder of the chest compression system 24, including the opposing upstanding legs 70 are positioned near the opposing ends of the back plate 62 and the locking mechanisms 72 are engaged.

For adjustment of the chest compression system 24 relative to the patient P, and/or removal of the chest compression system 24 after use, one or both of the locking mechanisms 72 may be releasably disengaged. A releasing member 74 coupled to each of the locking mechanisms 72 may receive an input from a user to disengage the opposing upstanding legs 70 from the back plate 62. The illustrated embodiment shows the releasing member 74 as a ring configured to be moved upwardly relative to the back plate 62 to disengage the locking mechanisms 72.

A main housing 76 is coupled to the opposing upstanding legs 70 opposite the back plate 62. It is appreciated that the main housing 76 and the opposing upstanding legs 70 may be at least partially formed of unitary construction, such as shown in FIGS. 3A-3C. The main housing 76, as implied by its name, accommodates or houses many of the electromechanical components of the chest compression system 24. Extending from the main housing 76 in a direction toward the back plate 62 is a piston rod 78 (covered by bellows in FIGS. 3A-3C) to which the chest pad 68 is mounted. The schematic representation of FIG. 4 shows the piston rod 78 coupled to a piston 80 within the main housing 76. The piston 80 may be actuated in with any suitable propulsion, for example, electric, electromagnetic, pneumatic, and the like. A control panel 84 is disposed on the main housing 76 with a user interface configured to receive inputs from the user. For example, FIGS. 3A-3C show a series of depressable buttons. In other embodiments, the control panel 84 may be remote from the chest compression system 24 such as a keyboard, smartphone, tablet, personal digital assistant (PDA), and the like. Further description of the operation of the chest compression system 24 will be omitted in the interest of brevity. Certain operative and structural features of the chest compression system 24 are further disclosed in U.S. Pat. No. 7,226,427, issued Jul. 5, 2007, and entitled SYSTEMS AND PROCEDURES FOR TREATING CARDIAC ARREST, the entire contents of which are hereby incorporated by reference.

It should be appreciated that even with the weight of the patient P properly positioned on the back plate 62, the weight distribution of the chest compression system 24 may render it prone to inadvertent movement on the patient support apparatus 22, particularly during transport. Yet it is imperative that the chest compressions performed during CPR, whether manual or automated, remain properly located near the tip of the breastbone of the patient P. To maintain the position of the chest compression system 24 relative to the patient support apparatus 22, the patient support apparatus 22 includes a harness assembly 86, as shown in FIGS. 1 and 2. The harness assembly 86 includes at least one retention strap 88 coupled to each of the opposing lengthwise sides of the support frame 30. The retention straps 88 may be, for example, coupled to the first and second frame rails 40, 42 and/or the first and second deck rails 48, 50 extending lengthwise along the support frame 30 (and/or the patient support deck 34). Alternatively, the retention straps 88 may be coupled to the intermediate support assembly 28 and/or any other suitable structure on the patient support apparatus 22. The retention straps 88 may be formed of any suitable materials configured to secure the chest compression system 24 to the patient support apparatus 22. In particular, the retention straps 88 should have mechanical characteristics, including tensile and breaking strengths, sufficient to restrain the patient P during transport, particularly in the event of increased or sudden impact forces (e.g., sharp turn or collision of a transport vehicle). For example, the retention straps 88 may be elongated, flat fabric woven strips, commonly known as webbing. FIGS. 1 and 2 show one retention strap 88 coupled on each of the opposing lengthwise sides of the support frame 30 and generally extending along an outer surface of the opposing upstanding legs 70 of the chest compression system 24. More particularly and with reference to FIG. 2, the harness assembly 86 of the illustrated embodiment includes a left retention strap 88l coupled to the first or left frame rail 40, and a right retention strap 88r coupled to the second or right frame rail 42. A first coupler 94l near an end of the left retention strap 88l is configured to releasably engage a complementary coupler 96l disposed on one of the opposing upstanding legs 70 of the chest compression system 24 when the back plate 62 is positioned on the patient support surface 38. A second coupler 94r near an end of the right retention strap 88r is configured to releasably engage a complementary coupler 96r disposed on the other opposing upstanding legs 70 of the chest compression system 24 when the back plate 62 is positioned on the patient support surface 38. More or less retention straps 88 may be utilized. For example, four retention straps 88 may be provided with each pair of retention straps coupled to the opposing upstanding legs 70 of the chest compression system 24 such that each pair of retention straps 88 may be arranged in a V-shaped configuration when viewed in elevation.

The couplers 94 near the end of the retention straps 88 couple the retention straps 88 to the complementary couplers 96 on one of the patient support apparatus 22 and the chest compression system 24. In other words, with the retention straps 88 mounted to or integrated with the patient support apparatus 22, the couplers 94 near the end of the each of the retention straps 88 releasably engages the complementary couplers 96 of the chest compression system 24 (see FIG. 3A). Alternatively, in certain embodiments the retention straps 88 may be integrated with the chest compression system 24 (see FIG. 3C), and the couplers 94 near the end of the each of the retention straps 88 releasably engages complementary couplers (not shown) of the patient support apparatus 22. The couplers 94 may be a hook, as shown in FIG. 3A, or alternatively a buckle-type connection (FIG. 3B), a clip, a loop, a hook-and-eye, keyway, bayonet or other suitable connection.

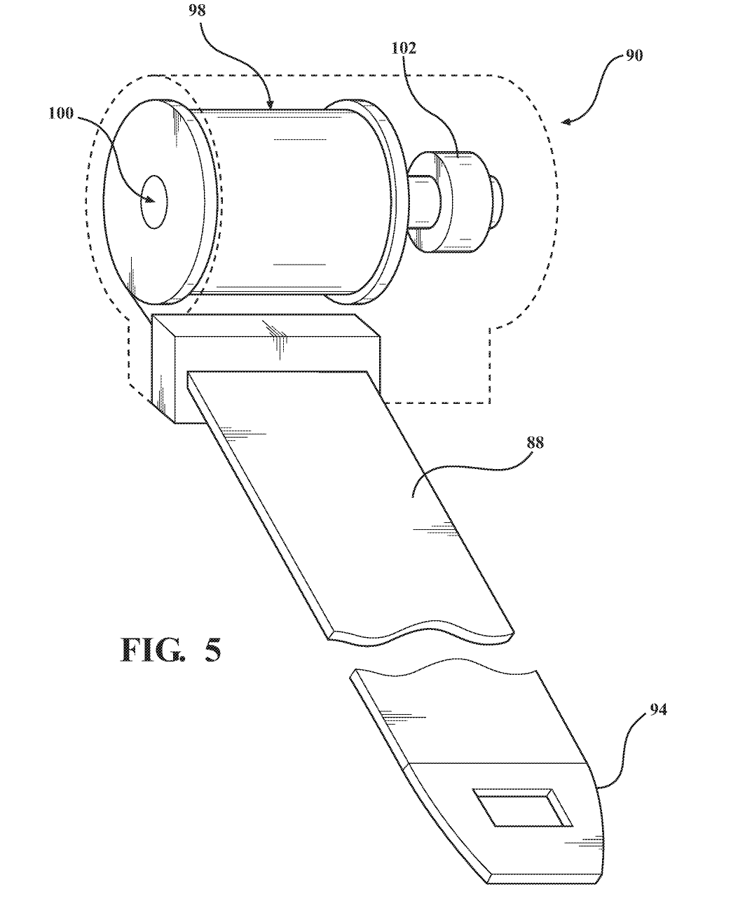

The securing of the chest compression system 24 to the patient support apparatus 22 is facilitated with a tension adjustment mechanism 92. The tension adjustment mechanism 92 is configured to lock and/or selectively adjust the tension of one or more of the retention straps 88 to secure the chest compression system 24 to the patient support apparatus 22 when the couplers 94 are coupled to the complementary couplers 96 of the chest compression system 24. In certain embodiments, the tension adjustment mechanism 92 includes an actuator 90. The actuator 90, in one exemplary embodiment shown in FIG. 5, includes a pulling element 98 coupled to the retention strap 88. The actuator 90 may comprise a rotor or winding device 100 secured to an end of the retention strap 88. The pulling element 98 may include a locking mechanism (not shown) configured to manually lock the retention strap 88 in response to sudden movement of the chest compression system 24 relative to the patient support apparatus 22. Exemplary locking mechanisms may include a weighted pendulum, a centrifugal clutch, a pretensioner, and the like.

Each of the actuators 90 couples one of the retention straps 88 to the opposing lengthwise sides of the support frame 30. The actuator 90 may be fixed, removably coupled, and/or movably coupled to the support frame 30. In other words, in one example, the actuators 90 may be decoupled from the frame rails 40, 42, 44, 46, the deck rails 48, 50, 52, 54, and/or other suitable structure to be moved and recoupled in a desired position. For another example, the actuators 90 may be slidable along the frame rails 40, 42, 44, 46 or other suitable structure. Once in the desired position, the actuator 90 may be locked to prevent further movement relative to the support frame 30. In such an example, the support frame 30 may include slots within which a key-like protrusion associated with the actuators 90 may be disposed, and/or the actuators 90 may comprise a throughbore which engages the frame rails 40, 42, 44, 46. Moreover, the retention straps 88 may be pivotally coupled to the actuators 90 (and/or the actuators 90 pivotally coupled to the support frame 30) so as to prevent kinking of the retention straps 88. It is contemplated that the harness assembly 86 provides for retrofitting the system 20 on existing patient support apparatuses.

In certain embodiments, the tension adjustment mechanism 92 is electromechanical in operation. More specifically, the actuators 90 of the tension adjustment mechanism 92 includes a motor 102 coupled to the winding device 100 and configured to wind the pulling element 98 to selectively adjust the tension of the retention strap(s) 88 of the harness assembly 86. The tension adjustment mechanism 92 may further include one or more controllers 104 and a sensor system in communication with the controller 104. For example, the winding device 100 is operably coupled to the motor 102, and the motor 102 is operably controlled by the controller 104. A sensor system may include one or more sensors 108 (see FIG. 1). The sensors 108 are configured to acquire data indicative of the tension in the retention straps 88, and provide corresponding signals to the controller 104. For example, the sensors 108 may be load cells or strain gauges operably coupled to the retention straps 88. The sensor system is configured to measure, determine, detect, or otherwise gather movement data. In addition to the aforementioned sensors 108, the sensor system may include sensors 110 (see FIGS. 3B and 3C), for example, an accelerometer and/or a gyroscope, configured to monitor minute movement of the chest compression system 24. The sensor system may provide the movement data to the controller 104 along with force signals from the sensors 108 such that the tension can be adjusted in real-time as a continuous feedback loop. Based on the force signal and/or other signals from the sensor system, the controller 104 is configured to control the one or more actuators 90. In addition to the controller 104, sensor system, and other electronic components disclosed herein, the patient support system 20 may comprise signal acquisition and processing circuitry, embedded software and algorithms, and the like, to carry out the functions described herein. For example, the sensor system and/or the controller 104 may be configured to wirelessly send and receive data from an ambulance, hospital room, and the like, having similar capabilities. The wireless connection may be effected through Wi-Fi, Bluetooth®, ZigBee®, infrared (IR), and the like, to transmit data between the controller 104, the sensor system, and the operating environment.

The controller 104 may be configured to operate the actuator 90 to substantially equalize the tension between a laterally opposing pair of the retention straps 88 to provide lateral stability to the chest compression system 24 securely positioned on the patient support surface 38. For example, the tension adjustment mechanism 92 may be associated with the left and right retention straps 88l, 88r to selectively adjust tension in one or both of the left and right retention straps 88l, 88r to secure the chest compression system 24 to the patient support apparatus 22. In such an example, the actuator 90 may include first and second actuators 90 in communication with the controller 104. The controller 104 is configured to operate at least one of the first and second actuators 90 to substantially equalize the tension between the left and right retention straps 88l, 88r to provide the lateral stability. Moreover, the controller 104 may be configured to operate the actuators 90 to provide stability to the chest compression system 24 secured to the patient support apparatus 22 while the automatic chest compressions are being provided to the patient as the patient support apparatus 22 is being moved along the surface. The sensors 108, 110 may detect a sudden change in movement of the chest compression system 24 (e.g., inertia as a hospital bed turns a corner or as an ambulance abruptly stops), and provide corresponding signals to the controller 104. In response to the signals received from the sensor system, the controller 104 may perform any number of responsive measures, including, but not limited to, controlling the tension adjustment mechanism 92 to ensure the chest compression system 24 and/or the patient P remains stabilized on the patient support surface 38.

Literature has suggested that elevating the patient's head to allow gravity to help improve blood flow in and out of the brain provides advantages during CPR. The concept, known as “heads-up CPR,” is based on the notion that CPR performed while the patient is flat and supine disadvantageously reduces the possibility of a cerebral perfusion gradient. Accordingly, in certain embodiments, the patient support apparatus 22 includes at least one movable section 112, 114, 116 (see FIG. 1), for example a fowler section 112 generally supporting the patient's upper body, and seat and leg sections 114, 116 generally supporting the patient's lower body. One or more of the movable sections 112, 114, 116 is configured to articulate relative to another one of the movable sections 112, 114, 116, the intermediate support assembly 28, or other structure of the patient support apparatus 22. In one example, movable sections 112, 114, 116 are articulated via one or more actuators (see actuator A in FIG. 1, which is coupled to the controller 104). More than one of the movable sections 112, 114, 116 may be controlled with a single actuator, and/or each one of the movable sections 112, 114, 116 may be coupled to a separate actuator. Often, the fowler section 112 articulates such that the patient P is positioned in an inclined position. The inclined position generally is defined as the upper body of the patient P being situated above horizontal at an angle relative to his or her lower body. The inclined position may be at an angle of 1, 10, 30, 45, 60, or 90 degrees, or any other suitable angle.

After moving the fowler section 112 to the desired inclined position, the harness assembly 86 must provide sufficient force to maintain the stability of the chest compression system 24 secured to the patient support apparatus 22 while the automatic chest compressions are being provided to the patient P while the patient P (and the chest compression system 24) is inclined. The controller 104 may operate the actuators 90 to selectively adjust the retention strap(s) 88 of the harness assembly 86 to a sufficient tension to maintain the stability of the chest compression system 24 oriented at an acute angle relative to horizontal. The actuator moving one or more of the movable sections 112, 114, 116 and the adjustment of the tension of the retention strap(s) 88 of the harness assembly 86 may be performed in a coordinated manner by the controller 104. The control panel 86 may have a preprogrammed option to direct the controller 104 to do so.

In one example where the patient P is transported in an ambulance or other vehicle, the sensor system comprises sensors that may indirectly track vehicle dynamics of the vehicle. The tracked vehicle dynamics may comprise acceleration, deceleration, g-force during turns, accidents, and the like. The tracked vehicle dynamics may be stored as data in the memory, effectively rendering, in many respects, the patient support system 20 a “black box” of the transport vehicle. In particular, data related to an automobile accident, or crash data, may be invaluable for any number of reasons and in any number of situations.

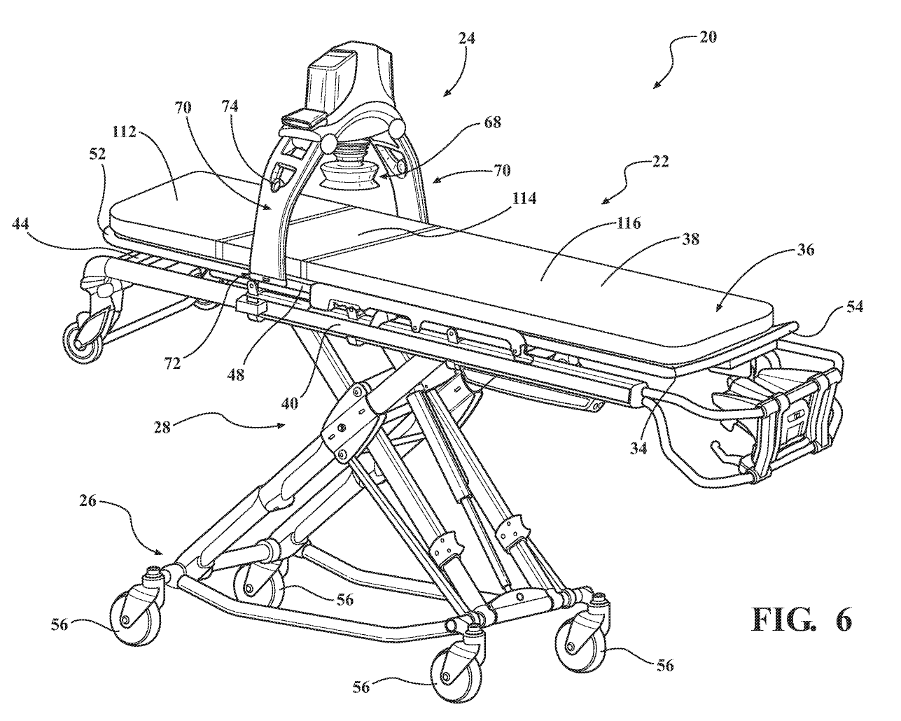

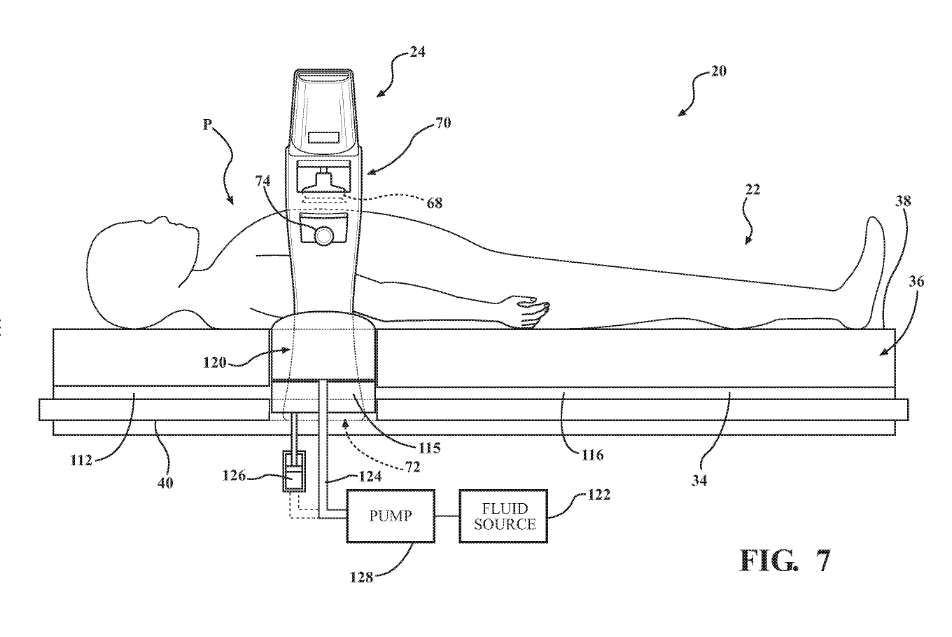

Referring now to FIGS. 6 and 7, the patient support system 20 in accordance with another exemplary embodiment is shown with the patient support apparatus 22 releasably securing the chest compression system 24. Certain features common between the previously described and present embodiments will be omitted in the interest of brevity. Whereas the chest compression system 24 of the previous embodiment includes the back plate 62 sized to be positioned on the patient support surface 38 and ensure the downward force provided by the chest pad 68 is absorbed by the chest of the patient P, the chest compression system 24 of the present embodiment lacks the back plate. Rather, each of the opposing upstanding legs 70 are coupled to the patient support apparatus 22. In the illustrated embodiment, each of the opposing upstanding legs 70 are coupled to the support frame 30, and more particularly to the first and second frame rails 40, 42. In other examples, the opposing upstanding legs 70 may be coupled to the first and second deck rails 48, 50 extending lengthwise along the patient support deck 34, the intermediate support assembly 28, and/or any other suitable structure on the patient support apparatus 22.

In certain embodiments, the locking mechanism 72 at the end of the opposing upstanding legs 70 may releasably couple with the corresponding structure of the patient support apparatus 22. Consequently, the chest compression system 24 may be quickly separable from the patient support apparatus 22 for storage, transport, and positioning and engagement of the chest compression system 24 with the patient P. The releasing member 74 coupled to each of the locking mechanisms 72 may receive an input from a user to disengage the opposing upstanding legs 70 from the corresponding structure of the patient support apparatus 22.

In embodiments where the patient P is supported on the mattress 36 at least partially formed from conformable materials for providing cushion to the patient P, it may be desirable to include features that ensure the downward force provided by the chest pad 68 is absorbed by the chest of the patient P and not undesirably dissipated. To that end, the patient support apparatus 22 may include one or more features configured to provide a suitably firm surface positioned against a portion of the back of the patient P opposite the chest pad 68. With continued reference to FIG. 7, the patient support apparatus 22 may include a bladder 120 in fluid communication with a fluid source 122 via the fluid line 124. A pump 128 is in communication with the controller 104 to control the selective inflation and deflation of the bladder 120. The bladder 120 may be integrated with or otherwise associated with the mattress 36. In the illustrated embodiment, the bladder 120 is at least partially recessed within the mattress 36. The bladder 120 may also rest upon, be disposed completely within, or be positioned below the mattress 36 (i.e., between the mattress 36 and the patient support deck 34). The bladder 120 is positioned substantially the patient P supported on the mattress 36 of the patient support apparatus 22, and the chest compression system 24 is coupled to the patient support apparatus 22.

Providing the bladder 120 positioned underneath the patient P opposite the chest pad 68 of the chest compression system 24 may increase force transference from the chest compression system 24 to the patient P. That is, inflation of the bladder 120 prior to or simultaneous with movement of the piston 80 and the chest pad 68 effectively “sandwiches” the patient P and prevents energy losses due to compressibility of the mattress 36, spinal lordosis, and the like. In one variant, the patient P is positioned on the mattress 36 supported on the movable sections 112, 116 of the patient support deck 34. Similar to previously described embodiments, the fowler section 112 and/or the leg section 116 may be movable relative to one another, for example, to provide for the inclined position of the patient support apparatus 22. In the present embodiment, one of the movable sections is a compressing section 115 that may be considered a functional aspect of the chest compression system 24. FIG. 7 shows the compressing section 115 positioned beneath the portion back of the patient P opposite the chest pad 68. The compressing section 115 moves upwardly to increase force transference from the chest compression system 24 to the patient P on the mattress 36. It is noted that while FIG. 7 shows the mattress 36 having discrete sections, one of which is positioned above the compressing section 115, such an arrangement is merely exemplary and a mattress of unitary construction may be utilized.

The compressing section 115 is coupled to an actuator 126, for example, a hydraulic cylinder in communication with the pump 128 and the fluid source 122. The actuator 126 moves between a first configuration in which the compressing section 115 is substantially aligned with the other movable sections 112, 116, and a second configuration in which the compressing section 115 is positioned above the other movable sections 112, 116. The pump 128 is in communication with the controller 104 and configured to direct fluid from the fluid source 122 (e.g., hydraulic fluid) with in a manner sufficient to provide for appreciable upward force necessary for the chest compressions. The controller 104 actuates the actuator 126 to move the actuator 126, providing an upward force to the mattress 36. The chest compression system 24 operates as previously described, resulting in the patient P being “sandwiched” and preventing energy losses due to compressibility of the mattress 36, spinal lordosis, and the like. Other related aspects of the patient support system 20 are disclosed in U.S. application Ser. No. 16/045,119, filed Jul. 25, 2018, and entitled PATIENT SUPPORT SYSTEM WITH CHEST COMPRESSION SYSTEM AND HARNESS ASSEMBLY WITH SENSOR SYSTEM, the entire contents of which are hereby incorporated by reference.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A patient support apparatus for being releasably coupled with a chest compression system configured to provide automatic chest compressions to a patient positioned between a back plate and a plunger of the chest compression system, said patient support apparatus comprising:
a base;
a frame supported by said base and comprising a patient support surface sized to support the back plate and at least a majority of the patient;
a harness assembly comprising:
retention straps coupled to said frame;
a coupler near an end of each of said retention straps with said couplers adapted to releasably engage complementary couplers of the chest compression system when the back plate is positioned on said patient support surface; and
a tension adjustment mechanism coupled to said retention straps to selectively adjust tension of one or more of said retention straps to secure the chest compression system to said patient support apparatus when said couplers are coupled to the complementary couplers of the chest compression system.

2. The patient support apparatus of claim 1, wherein said tension adjustment mechanism comprises a pulling element coupled to said frame and said retention straps, and a motor coupled to said pulling element and configured to wind said pulling element to selectively adjust the tension of said one or more of said retention straps.

3. The patient support apparatus of claim 2, further comprising a controller coupled to said motor with said controller configured to operate said motor to substantially equalize the tension between a laterally opposing pair of said retention straps to provide lateral stability to the chest compression system securely positioned on said patient support surface.

4. The patient support apparatus of claim 1, wherein said frame further comprises a frame rail extending along opposing lengthwise sides, wherein said tension adjustment mechanism is movably coupled to at least one of said frame rails for selectively positioning said retention straps along said opposing lengthwise sides.

5. The patient support apparatus of claim 3, further comprising a sensor system coupled to said tension adjustment mechanism and in communication with said controller with said controller configured to control the operation of said motor based on signals received from said sensor system indicative of the tension in said retention straps.

6. The patient support apparatus of claim 1, further comprising wheels coupled to said base and configured to facilitate moving said patient support apparatus along a surface, wherein said tension adjustment mechanism is configured to provide stability to the chest compression system secured to said patient support apparatus while the automatic chest compressions are being provided to the patient as said patient support apparatus is being moved along the surface.

7. The patient support apparatus of claim 1, wherein said frame comprises a patient support deck comprising a movable section movable relative to said base.

8. The patient support apparatus of claim 7, further comprising an actuator coupled to said movable section, and a controller coupled to said actuator with said controller configured to move said movable section to an inclined position to facilitate providing the automatic chest compressions with the chest compression system while an upper torso of the patient is in the inclined position.

9. The patient support apparatus of claim 1, wherein said couplers are one of a hook, a clip, and a loop.

10. The patient support apparatus of claim 4, wherein said tension adjustment mechanism is removably coupled to said frame rails.

11. The patient support apparatus of claim 1, further comprising a patient strap coupled to said frame and configured to secure the patient positioned on said patient support surface.

12. A patient support apparatus for being releasably coupled with a chest compression system configured to provide automatic chest compressions to a patient positioned between a back plate and a plunger of the chest compression system, said patient support apparatus comprising:
a base;
a frame supported by said base and sized to support the back plate and at least a majority of the patient;
a harness assembly comprising:
retention straps coupled to said frame;
a coupler near an end of each of said retention straps with said couplers adapted to releasably engage complementary couplers of the chest compression system when the back plate is positioned on said patient support surface;
a tension adjustment mechanism comprising:
a pulling element coupled to said frame and each of said retention straps;
an actuator coupled to said frame and each of said pulling elements and configured to wind said pulling elements to adjust tension of one or more of said retention straps when said couplers are coupled to the complementary couplers of the chest compression system; and
a controller coupled to said actuators and configured to operate at least one of said actuators to selectively adjust the tension of said one or more of said retention straps to secure the chest compression system to said patient support apparatus.

13. The patient support apparatus of claim 12, further comprising a sensor system coupled to said tension adjustment mechanism and in communication with said controller with said controller configured to control the operation of at least one of said actuators based on signals received from said sensor system indicative of the tension in said one or more of said retention straps.

14. The patient support apparatus of claim 13, wherein said controller is further configured to operate said actuators based on the signals to substantially equalize the tension between a laterally opposing pair of said retention straps to provide lateral stability to the chest compression system securely positioned on said patient support surface.

15. The patient support apparatus of claim 12, further comprising a patient strap coupled to said frame and configured to secure the patient on said patient support surface.

16. A patient support apparatus for being releasably coupled with a chest compression system configured to provide automatic chest compressions to a patient positioned between a back plate, a plunger, and opposing upstanding legs of the chest compression system, said patient support apparatus comprising:
a base;
a frame supported by said base and comprising a first frame rail and a second frame rail positioned along opposing lengthwise sides of said frame, said frame comprising a patient support surface sized to support the back plate and at least a majority of the patient between said first and second frame rails;
a harness assembly comprising:
a first retention strap coupled to said first frame rail;
a second retention strap coupled to said second frame rail;
a first coupler near an end of said first retention strap and configured to releasably engage a complementary coupler disposed on one of the opposing upstanding legs of the chest compression system when the back plate is positioned on said patient support surface;
a second coupler near an end of said second retention strap and configured to releasably engage a complementary coupler disposed on the other one of the opposing upstanding legs of the chest compression system when the back plate is positioned on said patient support surface; and
a tension adjustment mechanism associated with said left and right retention straps to selectively adjust tension in one or both of said left and right retention straps to secure the chest compression system to said patient support apparatus.

17. The patient support apparatus of claim 16, wherein said first and second couplers are one of a hook, a clip, and a loop.

18. The patient support apparatus of claim 16, wherein said tension adjustment mechanism comprises a first pulling element coupled to said first retention strap, a second pulling element coupled to said second retention strap, a first actuator coupled to said first pulling element, and a second actuator coupled to said second pulling element with said first and second actuators configured to wind a respective one of said first and second pulling elements to selectively adjust the tension of a respective one of said first and second retention straps when said first and second couplers are coupled to the complementary couplers of the chest compression system.

19. The patient support apparatus of claim 18, further comprising a controller coupled to said first and second actuators with said controller configured to operate at least one of said first and second actuators to substantially equalize the tension between said first and second retention straps to provide lateral stability to the chest compression system securely positioned on said patient support surface.

20. A chest compression system for use with a patient support apparatus, said chest compression system comprising:
a back plate;
legs extending from said back plate;
a housing coupled to said legs opposite said back plate;
a chest pad movable relative to the housing to apply automated chest compressions to a patient on the patient support apparatus;
retention straps coupled to one or more of said back plate, legs, and housing;
couplers near ends of said retention straps adapted to couple to complimentary couplers on the patient support apparatus; and
a tension adjustment mechanism coupled to said retention straps to selectively adjust tension of one or more of said retention straps to secure said chest compression system to the patient support apparatus when said couplers are coupled to the complementary couplers of the patient support apparatus.
